(19) United States
(12) Patent Application Publication
(10) Pub. No.: US 2026/0036752 A1
(43) Pub. Date: Feb. 5, 2026

(54) OPTICAL CONNECTOR

(71) Applicant: Fujikura Ltd., Tokyo (JP)

(72) Inventors: Tomoyuki Shinoda, Sakura-shi (JP); Toshiaki Nakajima, Sakura-shi (JP); Hidetoshi Katahira, Sakura-shi (JP); Hiroyuki Takamizawa, Sakura-shi (JP)

(73) Assignee: Fujikura Ltd., Tokyo (JP)

(21) Appl. No.: 19/150,037

(22) PCT Filed: Nov. 8, 2023
(86) PCT No.: PCT/JP2023/040181

§ 371 Date: Jul. 22, 2025

(30) Foreign Application Priority Data
Jan. 27, 2023 (JP) 2023-011163

(51) Int. Cl. G02B 6/38; G02B 6/42

(52) U.S. Cl. CPC G02B 6/381; G02B 6/421; G02B 6/4214; G02B 6/4219

(57) ABSTRACT

An optical connector includes: a ferrule in which an optical fiber is inserted and which has a connection end surface from which the optical fiber is exposed; and a waveguide member. The waveguide member has an incidence surface, a waveguide part which guides light incident from the incidence surface toward the side opposite to the connection end surface, and a scattering part which scatters the light guided by the waveguide part.

### CROSS-REFERENCE TO RELATED APPLICATIONS

The present application is a national stage application of PCT Application No. PCT/JP2023/040181, filed on Nov. 8, 2023, which claims priority to Japanese Patent Application No. 2023-011163, filed on Jan. 27, 2023. The contents of these documents are incorporated by reference in their entirety.

### TECHNICAL FIELD

The present invention relates to an optical connector.

### BACKGROUND

In the related art, a patch panel has been used to construct an optical network in a data center or the like. The patch panel includes a large number of adapters, and optical connectors are connected to these adapters. For example, the patch panel disclosed in Patent Document 1 includes an LED 131 and a photodiode 132 for detecting that the optical connector is connected to the adapter (port 116).

Patent Document 1: Specification of U.S. Pat. No. 8,116,434

A large number of optical connectors are connected to the patch panel. Therefore, it may be beneficial to improve the efficiency of the work associated with connecting the optical connector to the patch panel (“connection work”), work associated with disconnecting the optical connector from the patch panel (“disconnection work”), and the like. The efficiency of the above-described work may be further improved by notifying the worker of the connection status of the optical connector to the adapter using light.

### SUMMARY

Embodiments of the present invention provide an optical connector capable of further improving the efficiency of connection work and the like.

According to Aspect 1 of the present invention, there is provided an optical connector including: a ferrule into which an optical fiber is inserted and which has a connection end face at which the optical fiber is exposed; and a waveguide member, in which the waveguide member includes an incident surface, a waveguide portion that guides light incident from the incident surface to a front side which is a side opposite to the connection end face, and a scattering portion that scatters the light guided by the waveguide portion.

Aspect 2 of the present invention is the optical connector according to Aspect 1, further including: a housing configured to hold the ferrule inside, in which the scattering portion is positioned on the front side with respect to the housing.

Aspect 3 of the present invention is the optical connector according to Aspect 2, further including: a boot positioned on the front side with respect to the housing, in which the scattering portion faces the boot.

Aspect 4 of the present invention is the optical connector according to Aspect 2, in which the waveguide member is integrated with a boot positioned on the front side with respect to the housing.

Aspect 5 of the present invention is the optical connector according to any one of Aspects 1 to 4, in which a reflecting portion is provided on a part of the incident surface.

According to one or more of the above-described aspects of the present invention, it is possible to provide an optical connector capable of further improving the efficiency of connection work and the like.

### BRIEF DESCRIPTION OF DRAWINGS

FIG. 1 An overall view of an optical connection system according to one or more embodiments.

FIG. 2 A view in which a lid of a patch panel in FIG. 1 is removed according to one or more embodiments.

FIG. 3 A block diagram showing a configuration of a patch panel according to one or more embodiments.

FIG. 4 A schematic view showing a waveguide according to one or more embodiments.

FIG. 5 A cross-sectional view taken along the line V-V in FIG. 4 according to one or more embodiments.

FIG. 6 An enlarged view of the periphery of an adapter in FIG. 1 according to one or more embodiments.

FIG. 7 A perspective view of an optical connector according to one or more embodiments.

FIG. 8 A cross-sectional view of the optical connector according to one or more embodiments.

FIG. 9 An enlarged view of the periphery of the adapter according to one or more embodiments.

### DETAILED DESCRIPTION

Hereinafter, an optical connector, a patch panel, and an optical connection system according to one or more embodiments will be described with reference to the drawings.

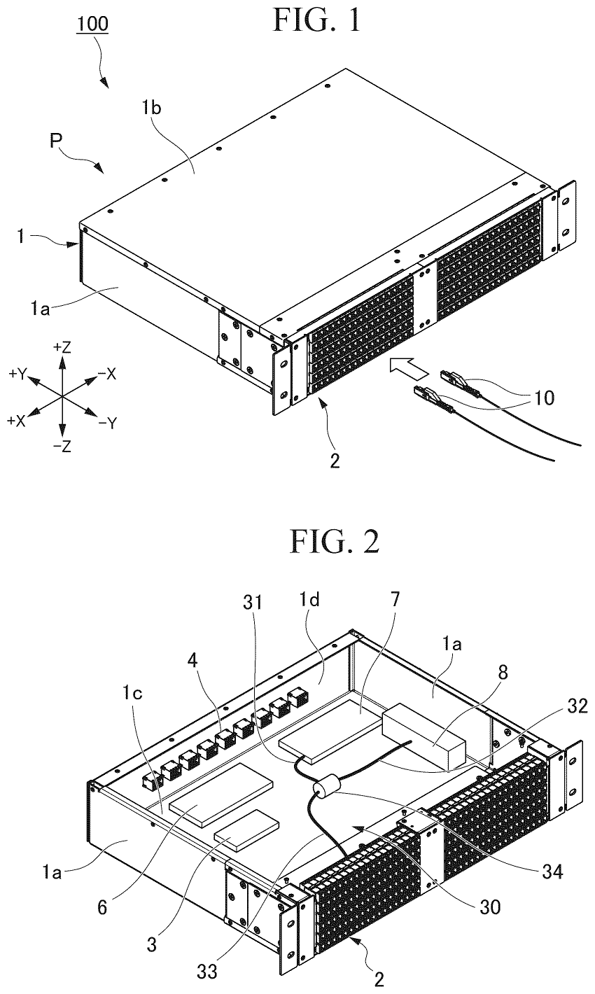

As shown in FIG. 1, an optical connection system 100 includes a patch panel P and a plurality of optical connectors 10. The patch panel P includes a housing 1 and a plurality of adapters (first adapters) 2. As shown in FIGS. 1 and 2, the housing 1 has a pair of side walls 1a, a lid 1b, a bottom wall 1c, and a rear wall 1d. A control portion 3, a power supply circuit 6, a light source 7, a light-receiving portion 8, a waveguide 30, and the like are disposed inside the housing 1. A plurality of second adapters 4 are provided on the rear wall 1d.

The optical connector 10 is connected to the adapter 2. Although not shown in FIG. 2, an optical circuit (for example, a plurality of optical fibers) for optically connecting the adapter 2 and the second adapter 4 is provided inside the housing 1. The optical connection system 100 is configured to optically connect the optical connector 10 connected to the adapter 2 and the second adapter 4. Such an optical connection system 100 is disposed in, for example, a data center or the like.

### Definition of Direction

A direction in which the optical connector 10 is moved in a case where the optical connector 10 is inserted into the adapter 2 is referred to as a front-rear direction Y. The adapter 2 has an insertion port 2a (refer to FIG. 6) into which the optical connector 10 is inserted. In the front-rear direction Y, a side (a −Y side) to which the insertion port 2a faces is referred to as a front side, and a side (a +Y side) opposite to the front side is referred to as a rear side. One direction orthogonal to the front-rear direction Y is referred to as a left-right direction X. One side (+X side) in the left-right direction X is referred to as a left side, and a side (−X side) opposite to the left side is referred to as a right side. A direction orthogonal to both the front-rear direction Y and the left-right direction X is referred to as an up-down direction Z. In the up-down direction Z, a side (+Z side) on which the lid 1b is disposed is referred to as an upper side, and a side (−Z side) on which the bottom wall 1c is disposed is referred to as a lower side. The up-down direction Z may not coincide with the vertical direction.

The plurality of adapters 2 are disposed at an end part of the patch panel P on the front side. These adapters 2 are arranged side by side in both the left-right direction X and the up-down direction Z. The patch panel P includes a plurality of waveguides 30 corresponding to the number of connectable optical connectors 10. In FIG. 2, only one waveguide 30 is shown, and the remaining waveguides 30 are not shown.

As shown in FIG. 2, the waveguide 30 includes a first branch path 31, a second branch path 32, a main waveguide portion 33, and a branch portion 34. The first branch path 31, the second branch path 32, and the main waveguide portion 33 are, for example, optical fibers made of plastic. However, the first branch path 31, the second branch path 32, and the main waveguide portion 33 may be optical fibers made of glass. Alternatively, a part or all of the waveguide 30 may be a substrate-type optical waveguide.

In a case where the first branch path 31, the second branch path 32, and the main waveguide portion 33 are optical fibers made of plastic, the number of adapters 2 that can be accommodated in the patch panel P can be increased as compared with the case where the optical fibers are made of glass. As a result, the number of optical connectors 10 that can be connected to the patch panel P increases, and the density can be increased. In addition, it is possible to suppress the unit price of the adapter 2 (port).

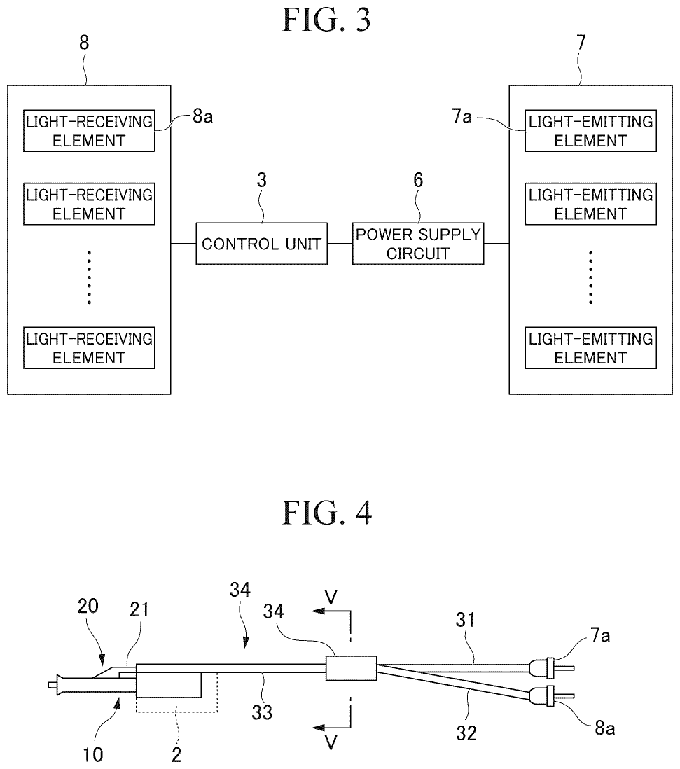

FIG. 3 is a functional block diagram of the patch panel P. As shown in FIG. 3, the control portion 3 is electrically connected to the light-receiving portion 8. In addition, the control portion 3 is electrically connected to the light source 7 via the power supply circuit 6. Although not shown in FIG. 2, the patch panel P includes a wiring for electrically connecting the control portion 3, the power supply circuit 6, the light source 7, the light-receiving portion 8, and the like. For example, the control portion 3 includes hardware such as a central processing unit (CPU), an application specific integrated circuit (ASIC), and the like. The light source 7 includes a plurality of light-emitting elements 7a. The light-receiving portion 8 includes a plurality of light-receiving elements 8a.

The control portion 3 controls the power supply circuit 6 to switch the state of the light-emitting element 7a of the light source 7. For example, the control portion 3 may switch the state of the light-emitting element 7a according to the detection result of the light by the plurality of light-receiving elements 8a. The “state of the light-emitting element 7a” is lighting, turning off, blinking, color, and the like. In addition, the control portion 3 may communicate with the outside. Then, the control portion 3 may switch the state of the light-emitting element 7a based on a command from the outside. The “outside” is, for example, a system or the like that manages the operation of the data center.

In one or more embodiments, the plurality of light-emitting elements 7a and the plurality of insertion ports 2a correspond to each other on a one-to-one basis. In addition, a dichroic LED is used as the light-emitting element 7a. The dichroic LED is a type of light emitting diode (LED) and is capable of emitting two different colors. Hereinafter, two different colors are each referred to as a “first display color” and a “second display color”. The patch panel P is configured to display the first display color or the second display color on each light-emitting portion 33a (described below) according to the connection status of the optical connector 10 with respect to each insertion port 2a. For example, in a case where the optical connector 10 is not connected to any insertion port 2a, the first display color is displayed on the light-emitting portion 33a corresponding to the insertion port 2a. Alternatively, in a case where the optical connector 10 is connected to the insertion port 2a, the second display color is displayed on the light-emitting portion 33a corresponding to the insertion port 2a. For example, the first display color is red and the second display color is green.

However, the combination of the first display color and the second display color can be changed. Yellow, blue, white, and the like may be used. In addition, the state of the corresponding insertion port 2a may be displayed by changing the lighting state of the light-emitting element 7a. The lighting state includes, for example, continuous lighting, blinking (repetition of lighting and turning off), and the like. In addition, the light-emitting element 7a may be an LED other than the dichroic LED or may not be an LED. Alternatively, the light source 7 may have a plurality of light-emitting elements 7a having different types (colors). Then, a plurality of light-emitting elements 7a having different types (colors) may cause light to be incident on one waveguide 30. In this case, the waveguide 30 may have a plurality of first branch paths 31 described below.

The plurality of light-receiving elements 8a and the plurality of insertion ports 2a correspond to each other on a one-to-one basis. The light-receiving element 8a can detect light. More specifically, the light-receiving element 8a generates an electric signal by receiving light. The electric signal generated by the light-receiving element 8a is input to the control portion 3. A photodiode can be used as the light-receiving element 8a. The function of the light-receiving element 8a in the patch panel P will be described below.

FIG. 4 is a schematic view showing a connection relationship between the waveguide 30, the light-emitting element 7a, the light-receiving element 8a, and the optical connector 10. In FIG. 4, the first branch path 31, the second branch path 32, and the main waveguide portion 33 are simplified in a linear shape. However, as shown in FIG. 2, in reality, each part of the waveguide 30 is disposed to be curved inside the housing 1. In particular, a large number of waveguides 30 are disposed in the housing 1. Accordingly, in order to effectively use the space, each part (the first branch path 31, the second branch path 32, and the main waveguide portion 33) of the waveguide 30 is disposed to be curved. In addition, the length of each part of the waveguide 30 can be appropriately changed.

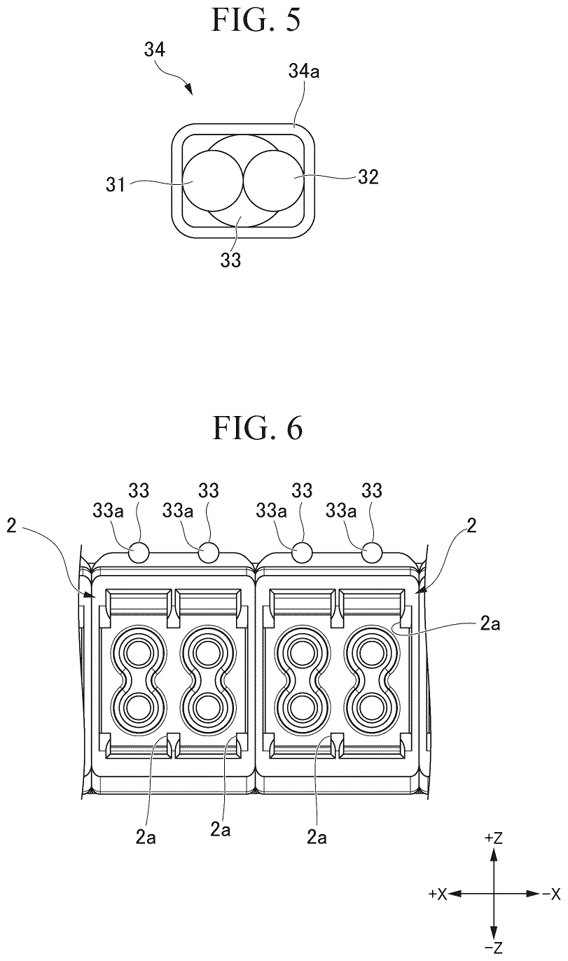

As shown in FIG. 4, the first branch path 31 optically connects the light-emitting element 7a of the light source 7 and the branch portion 34. The second branch path 32 optically connects the light-receiving element 8a of the light-receiving portion 8 and the branch portion 34. FIG. 5 is a cross-sectional view taken along the line V-V in FIG. 4. As shown in FIG. 5, the branch portion 34 has a sheath 34a. The sheath 34a accommodates each of end parts of the first branch path 31, the second branch path 32, and the main waveguide portion 33. The sheath 34a maintains a state in which the first branch path 31 and the second branch path 32 are optically connected to the main waveguide portion 33.

In the example of FIG. 5, the sheath 34a has a rectangular tubular shape. However, the shape of the sheath 34a may be changed. For example, the sheath 34a may have a cylindrical shape. The outer diameter of the main waveguide portion 33 is larger than the outer diameter of the first branch path 31 and the outer diameter of the second branch path 32. For example, the main waveguide portion 33 is an optical fiber having an outer diameter of 0.75 mm, and the first branch path 31 and the second branch path 32 are optical fibers having outer diameters of 0.5 mm.

The main waveguide portion 33, the first branch path 31, and the second branch path 32 are realized by, for example, a plastic fiber. As a result, it is possible to configure the optical fiber at a low cost as compared with a case where a fiber made of glass is used.

In the branch portion 34, an end face of the first branch path 31 abuts an end face of the main waveguide portion 33. Therefore, the light emitted from the light-emitting element 7a propagates in the first branch path 31 toward the branch portion 34 and is incident into the main waveguide portion 33. Similarly, the end face of the second branch path 32 abuts the end face of the main waveguide portion 33. Therefore, the return light (described below) propagated in the main waveguide portion 33 toward the branch portion 34 is incident into the second branch path 32. However, as long as the first branch path 31, the second branch path 32, and the main waveguide portion 33 are optically connected to each other, the structure of the branch portion 34 can be changed. For example, the first branch path 31 and the second branch path 32 may be fusion-connected to the main waveguide portion 33.

FIG. 6 is an enlarged view of the adapter 2 as viewed from the front side. As shown in FIG. 6, the adapter 2 has the insertion port 2a into which the optical connector 10 is to be inserted. In one or more embodiments, for example, one adapter 2 for a duplex-type connector has two insertion ports 2a. That is, two optical connectors 10 can be connected to one adapter 2. The light-emitting portion 33a of the main waveguide portion 33 is disposed on an upper side of each insertion port 2a of the adapter 2. That is, the insertion port 2a and the light-emitting portion 33a correspond to each other on a one-to-one basis. The light-emitting portion 33a is an end face of the main waveguide portion 33. The light emitted from the light-emitting element 7a propagates in the main waveguide portion 33 and is radiated from the light-emitting portion 33a. The number of insertion ports 2a of the adapter 2 may be one. In this case, the adapter 2 and the light-emitting portion 33a correspond to each other on a one-to-one basis.

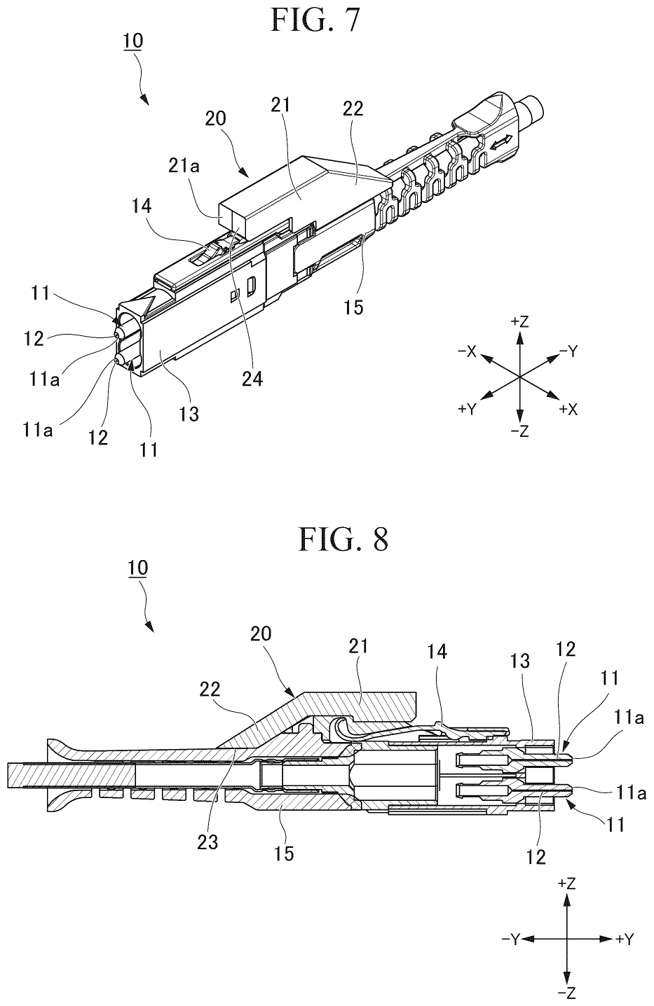

As shown in FIGS. 7 and 8, the optical connector 10 includes two ferrules 11, two optical fibers 12, a housing 13, a locking protrusion 14, a boot 15, and a waveguide member 20. However, the number of the ferrules 11 and the optical fibers 12 of the optical connector 10 may be one or three or more. The ferrule 11 has a connection end face 11a facing the rear side (+Y side). An insertion hole for inserting the optical fiber 12 is formed in the ferrule 11. The insertion hole is open to the connection end face 11a of the ferrule 11. The optical fiber 12 is exposed at the connection end face 11a. Although a detailed description will be omitted, the optical connector 10 includes a biasing member that biases the ferrule 11 toward a connection end face 11a side. The housing 13 accommodates the biasing member, the ferrule 11, and the like inside.

The locking protrusion 14 protrudes upward from the housing 13. In a case where the optical connector 10 is inserted into the insertion port 2a of the adapter 2, the locking protrusion 14 enters the locking hole of the adapter 2. As a result, the position of the optical connector 10 with respect to the adapter 2 is determined. The boot 15 is positioned on the front side (−Y side) with respect to the housing 13. The boot 15 is formed of a material having elasticity. A cable portion extends from the boot 15 toward the front side. The cable portion has an outer sheath that accommodates the optical fiber 12.

The waveguide member 20 is positioned above the housing 13 and the boot 15. As shown in FIGS. 7 and 8, the waveguide member 20 includes a first waveguide portion 21 and a second waveguide portion 22. The first waveguide portion 21 extends linearly in the front-rear direction Y. The first waveguide portion 21 includes an incident surface 21a. The incident surface 21a is an end face facing the rear side (+Y side) of the first waveguide portion 21. A reflecting portion 24 is provided on a part of the incident surface 21a. In one or more embodiments, a mirror is used as the reflecting portion 24. The mirror as the reflecting portion 24 is attached to the incident surface 21a. However, for example, the reflecting portion 24 may be formed by performing a plating treatment on a part of the incident surface 21a.

The second waveguide portion 22 is inclined downward as it goes toward the front side. The second waveguide portion 22 is connected to an end part of the first waveguide portion 21 on the front side. The first waveguide portion 21 and the second waveguide portion 22 guide light inside. As a material of the first waveguide portion 21 and the second waveguide portion 22, for example, a transparent resin can be adopted. The lower surface of the second waveguide portion 22 is used as a scattering portion 23 that scatters light. In a case where the optical connector 10 is connected to the adapter 2, the incident surface 21a and the reflecting portion 24 face the light-emitting portion 33a of the main waveguide portion 33 (refer to FIGS. 4 and 6). In addition, the scattering portion 23 faces the boot 15.

Next, an action of the optical connection system 100 configured as described above will be described. The optical connection system 100 has a function of displaying the connection status of the optical connector 10 to the insertion port 2a using the light-emitting portion 33a. This function is referred to as a housing-side display function. In addition, the optical connection system 100 has a function of displaying the connection status using the scattering portion 23. This function is referred to as a connector-side display function. The “connection status” can include, for example, a “disconnected state”, a “connected state”, an “alert state”, and the like. The “disconnected state” is a state in which the optical connector 10 is not connected to any insertion port 2a. The “connected state” is a state in which the optical connector 10 is normally connected to any insertion port 2a. The “alert state” is a state in which, although the optical connector 10 is connected to any insertion port 2a, for example, a malfunction has occurred on the network and maintenance is recommended. Hereinafter, a more detailed description will be given.

### Housing-side Display Function

The control portion 3 causes the plurality of light-emitting elements 7a of the light source 7 to emit light of the first display color via the power supply circuit 6. In this case, all the light-emitting elements 7a may emit light. Alternatively, only the light-emitting element 7a corresponding to the insertion port 2a that may be used may emit light. The light of the first display color emitted by the light-emitting element 7a passes through the first branch path 31 of the corresponding waveguide 30 and is incident on the main waveguide portion 33. In addition, the light of the first display color reaches the light-emitting portion 33a (the end face of the main waveguide portion 33).

Here, in a case where the optical connector 10 is connected to any insertion port 2a, the reflecting portion 24 of the optical connector 10 and the light-emitting portion 33a face each other. Therefore, a part of the light radiated from the light-emitting portion 33a is reflected by the reflecting portion 24 and is incident on the main waveguide portion 33 again. In this way, the light reflected by the reflecting portion 24 is referred to as “return light”. The return light travels through the main waveguide portion 33 toward the branch portion 34 and is incident on the second branch path 32 in the branch portion 34. Further, the return light travels through the second branch path 32 and is incident on the light-receiving element 8a. The light-receiving element 8a receives the return light to generate an electric signal and input the electric signal to the control portion 3. Accordingly, the control portion 3 can determine that the optical connector 10 is inserted into the insertion port 2a corresponding to the light-receiving element 8a.

Based on the above determination, the control portion 3 causes the light-emitting element 7a corresponding to the insertion port 2a into which the optical connector 10 is inserted to emit light of the second display color. That is, the color of the light of the target light-emitting element 7a is switched from the first display color to the second display color. As a result, light of the second display color is radiated from the light-emitting portion 33a. On the other hand, in the light-emitting portion 33a corresponding to the insertion port 2a into which the optical connector 10 is not inserted, the light of the first display color is continuously radiated. As described above, the optical connection system 100 can cause the plurality of light-emitting portions 33a of the patch panel P to emit light by dividing into the first display color and the second display color according to the connected state and the disconnected state.

In addition, the control portion 3 may blink the light-emitting portion 33a of the insertion port 2a of the maintenance target in the first display color or the second display color. Accordingly, a user can grasp the connection status of a large number of insertion ports 2a as follows.
First display color (continuous lighting): connected state
Second display color (continuous lighting): disconnected state
First display color or second display color (blinking): alert state

In the data center or the like, since the user can easily grasp the connection status of a large number of insertion ports 2a, it is possible to improve work efficiency. The method of displaying the connection status is merely an example and can be appropriately changed. Furthermore, for example, by adding a method such as alternately lighting the first display color and the second display color, four or more types of status may be displayed. The blinking pattern (time interval or the like) of the first display color or the second display color may be changed.

### Connector-side Display Function

In a case where the optical connector 10 is connected to the insertion port 2a, a part of the light radiated from the light-emitting portion 33a is incident into the waveguide member 20 from the incident surface 21a. This light travels through the first waveguide portion 21 and the second waveguide portion 22 and reaches the scattering portion 23. In the scattering portion 23, the light is scattered. In one or more embodiments, the scattering portion 23 faces the boot 15. Therefore, the boot 15 also appears to be emitting light from the user's point of view.

As described in the housing-side display function, the light emitted from the light-emitting portion 33a corresponds to the connection status. Therefore, the user can grasp the connection status by visually recognizing the light scattered by the scattering portion 23. In a case where a large number of optical connectors 10 are densely connected to the patch panel P, there is a possibility that the light-emitting portion 33a is difficult to be directly visible. Even in such a case, since the scattering portion 23 provided in the optical connector 10 scatters light, the visibility of the light can be improved. In particular, in one or more embodiments, since the boot 15 positioned at the end part of the optical connector 10 on the front side appears to be emitting light, the visibility can be further improved.

As described above, the optical connector 10 of one or more embodiments includes the ferrule 11 into which the optical fiber 12 is inserted and which has the connection end face 11a at which the optical fiber 12 is exposed, and the waveguide member 20. The waveguide member 20 includes the incident surface 21a, the waveguide portion (the first waveguide portion 21 and the second waveguide portion 22) that guides light incident from the incident surface 21a to the front side (−Y side) which is a side opposite to the connection end face 11a, and the scattering portion 23 that scatters the light guided by the waveguide portion. According to this configuration, the user can be notified of the connection status of the optical connector 10 using the light scattered by the scattering portion 23. As a result, it is possible to further improve the efficiency of the connection work and the like.

In addition, the optical connector 10 includes the housing 13 configured to hold the ferrule 11 inside, and the scattering portion 23 is positioned on the front side (−Y side) with respect to the housing 13. According to this configuration, the user can visually recognize the scattering portion 23 on the front side closer to the user. Therefore, even in a case where the optical connectors 10 are densely connected to the patch panel P, the visibility of the scattering portion 23 is improved.

In addition, the optical connector 10 includes the boot 15 positioned on the front side with respect to the housing 13, and the scattering portion 23 faces the boot 15. According to this configuration, the light scattered by the scattering portion 23 is reflected by the boot 15, and the boot 15 itself appears to be emitting light. Therefore, the visibility of light by the user can be further improved.

In addition, the reflecting portion 24 is provided on a part of the incident surface 21a. According to this configuration, the light emitted from the light-emitting element 7a of the patch panel P can be reflected by the reflecting portion 24. Then, the control portion 3 can determine whether or not the optical connector 10 is inserted into the adapter 2 by detecting the return light by the light-receiving element 8a of the patch panel P.

In addition, the patch panel P according to one or more embodiments includes the adapter 2 having the insertion port 2a into which the optical connector 10 is inserted, the light-emitting portion 33a disposed adjacent to the insertion port 2a, the light source 7 configured to emit light, the light-receiving element 8a configured to detect light, and the waveguide 30, in which the waveguide 30 includes the branch portion 34, the first branch path 31 that guides the light emitted from the light source 7 to the branch portion 34, the main waveguide portion 33 that guides the light guided by the first branch path 31 to the light-emitting portion 33a, and the second branch path 32 that guides the light, which has been guided by the main waveguide portion 33 toward the branch portion 34, to the light-receiving element 8a. According to this configuration, the user can recognize the connection status and the like of the insertion port 2a by causing the light-emitting portion 33a disposed adjacent to the insertion port 2a to emit light. In addition, in a case where the optical connector 10 is connected to the insertion port 2a, the return light reflected by the optical connector 10 can be guided to the light-receiving element 8a using the waveguide 30. Therefore, it is possible to detect whether or not the optical connector 10 is connected by using the light-receiving element 8a. With these actions, it is possible to further improve the efficiency of the connection work and the like.

In addition, the patch panel P further includes the control portion 3 configured to control the light source 7 based on a detection result of the light by the light-receiving element 8a. According to this configuration, the lighting state of the light source 7 can be switched depending on whether or not the optical connector 10 is inserted into the insertion port 2a. That is, the display of light in the light-emitting portion 33a can be switched. Therefore, various types of information can be shown to the user by using the light-emitting portion 33a.

In addition, the light source 7 can emit light of two different colors. Specifically, the light source 7 may include a light-emitting element 7a that is a dichroic LED. Alternatively, the light source 7 may include a plurality of types of light-emitting elements 7a that emit light of different colors. In these cases, the color of the light in the light-emitting portion 33a can be switched depending on the connection status of the optical connector 10 to the insertion port 2a. That is, the connection status can be shown to the user by using the difference in color.

In addition, the control portion 3 switches a color of the light emitted from the light source 7 based on the detection result of the light by the light-receiving element 8a. With this configuration, the color of light in the light-emitting portion 33a can be automatically switched.

In addition, the main waveguide portion 33 is an optical fiber, and the light-emitting portion 33a is an end face of the optical fiber (main waveguide portion 33). According to this configuration, the light-emitting portion 33a can be disposed in a small space around the adapter 2. Accordingly, the size of the patch panel P can be reduced. In particular, the light-emitting portion 33a can be provided without disposing the substrate or the like around the adapter 2. Therefore, it is possible to increase the density of the adapters 2 in the patch panel P, and the optical connectors 10 can be connected with high density.

### Modification Example

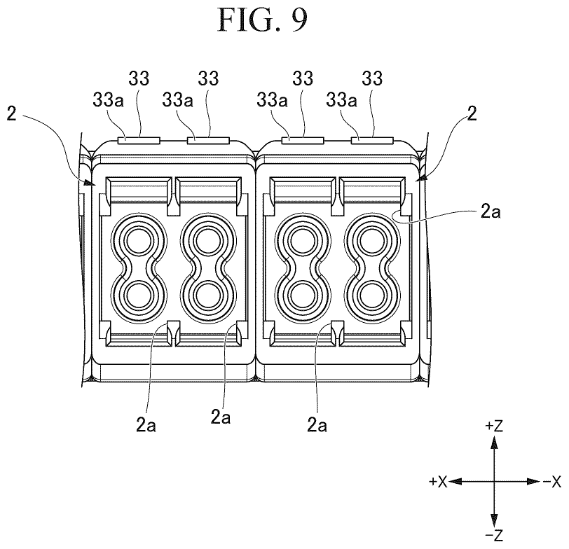

Next, a modification example of one or more of the above-described embodiments will be described with reference to FIG. 9. As shown in FIG. 9, the light-emitting portion 33a may have a flat shape as viewed from the front-rear direction Y. More specifically, the dimension of the light-emitting portion 33a of the present modification example in the up-down direction Z is smaller than the dimension of the light-emitting portion 33a in the left-right direction X. Such a light-emitting portion 33a can be formed by, for example, the following method. As a first method, an end part on the front side (−Y side) of the member (for example, an optical fiber made of plastic) serving as the main waveguide portion 33 may be deformed. In a case of being deformed, the member serving as the main waveguide portion 33 may be heated and softened, and a pressure in the up-down direction Z may be applied.

As a second method, the end part on the front side of the member serving as the main waveguide portion 33 may be subjected to cutting processing. As a third method, a flat member may be used as the main waveguide portion 33. According to the first method and the second method, in the main waveguide portion 33, the vicinity of the light-emitting portion 33a has a flat shape, and the other portion has a columnar shape. According to the third method, the entire main waveguide portion 33 has a flat shape.

In this way, by making the light-emitting portion 33a have a flat shape, a plurality of the adapters 2 can be disposed at small intervals in the up-down direction Z. That is, in the up-down direction Z, a larger number of the adapters 2 can be densely disposed. Accordingly, the number of optical connectors 10 that can be connected to the patch panel P can be increased.

The technical scope of the present invention is not limited to the above-described embodiments, and various modifications can be made without departing from the scope of the present invention.

For example, the waveguide member 20 may be integrated with the boot 15 positioned on the front side with respect to the housing 13. That is, the boot 15 itself may be formed of a material (for example, a transparent resin) capable of guiding light. The boot 15 may include an incident surface, a waveguide portion that guides light incident from the incident surface to a side opposite to the connection end face, and a scattering portion that scatters the light guided by the waveguide portion. In this case as well, the same effects as those of embodiments described above are obtained.

It should be noted that the aforementioned control portion 3 includes a computer system inside. A program for realizing the function of the control portion 3 may be recorded on a computer-readable recording medium, and the program may be read and executed by the computer system to perform the processing in the control portion 3.

In addition, it is possible to appropriately replace the constituent elements in the above-described embodiments with well-known constituent elements, and the above-described embodiments and modification examples may be appropriately combined without departing from the scope of the present invention.

### REFERENCE SIGNS LIST

10 Optical connector
11 Ferrule
11a Connection end face
12 Optical fiber
13 Housing
15 Boot
20 Waveguide member
21 Waveguide portion
21a Incident surface
23 Scattering portion
24 Reflecting portion

1. An optical connector comprising:
a ferrule into which an optical fiber is inserted and that has a connection end face on a first side of the optical connector at where the optical fiber is exposed; and
a waveguide member including:
an incident surface;
a waveguide portion that guides light incident from the incident surface to a second side of the optical connector opposite to the first side; and
a scattering portion that scatters the light guided by the waveguide portion.

2. The optical connector according to claim 1, further comprising:
a housing that holds the ferrule therein,
wherein the scattering portion is positioned on the second side of the waveguide member with respect to the housing.

3. The optical connector according to claim 2, further comprising:
a boot positioned on the second side of the waveguide member with respect to the housing,
wherein the scattering portion faces the boot.

4. The optical connector according to claim 2,
wherein the waveguide member is integrated with a boot positioned on the second side of the waveguide member with respect to the housing.

5. The optical connector according to claim 1,
wherein a reflecting portion is provided on a part of the incident surface of the waveguide member.

6. The optical connector according to claim 3,
wherein the waveguide member is integrated with a boot positioned on the second side of the waveguide member with respect to the housing.

7. The optical connector according to claim 2,
wherein a reflecting portion is provided on a part of the incident surface of the waveguide member.

8. The optical connector according to claim 3,
wherein a reflecting portion is provided on a part of the incident surface of the waveguide member.

9. The optical connector according to claim 4,
wherein a reflecting portion is provided on a part of the incident surface of the waveguide member.

10. The optical connector according to claim 6,
wherein a reflecting portion is provided on a part of the incident surface of the waveguide member.
